(19) United States
(12) Patent Application Publication
(10) Pub. No.: US 2016/0236648 A1
(43) Pub. Date: Aug. 18, 2016

(54) SYSTEM AND METHOD FOR PREVENTING VEHICLE FROM STARTING WHEN SAFETY BELT IS NOT ENGAGED

(71) Applicant: Brian L. Varner, Holton, KS (US)

(72) Inventor: Brian L. Varner, Holton, KS (US)

(21) Appl. No.: 15/044,798

(22) Filed: Feb. 16, 2016

Related U.S. Application Data
(60) Provisional application No. 62/265,705, filed on Dec. 10, 2015.
(60) Provisional application No. 62/116,798, filed on Feb. 16, 2015.

(51) Int. Cl. B60R 22/48

(52) U.S. Cl. CPC B60R 22/48; B60R 2022/4891; B60R 2022/4816

(57) ABSTRACT

A system and method for improving usage of safety belts during operation of vehicles by preventing them from starting when the belts are not engaged. A vehicle includes an onboard computer, a safety belt monitoring system, seats, and safety belts, and the system includes a connector and a hand-held unit. The connector allows for communicating with the computer, and the hand-held unit allows for communicating with the computer via the connector in order to program the computer to require both entry of a code and engagement of the belts of some or all occupied seats, as determined by the safety belt monitoring system, before allowing the vehicle to start. The hand-held unit may also allow for programming the onboard computer to require that the code be re-entered before allowing the vehicle to start again if a belt is disengaged during operation and the transmission is not in “park” or “neutral”.

### RELATED APPLICATION

The present U.S. non-provisional patent application is related to and claims priority benefit of a first earlier-filed U.S. provisional patent application titled “Plug-In Controller Preventing Vehicle Start-Up without Application of Safety Belts,” Ser. No. 62/116,798, filed Feb. 16, 2015, and of a second earlier-filed U.S. provisional patent application titled “Controller Preventing Vehicle Start-Up Without Application of Safety Belts,” Ser. No. 62/265,705, filed Dec. 10, 2015. The entire contents of the identified earlier-filed applications are hereby incorporated by reference into the present application.

### FIELD

The present invention relates to systems and methods for controlling the operation of vehicles, and, more particularly, to a system and method for controlling the operation of a vehicle based on the engagement of a safety belt.

### BACKGROUND

Operators of motor vehicles who do not engage their vehicle safety belts may be exposed to increased risk of physical injury and death resulting from vehicular accidents. The use of safety belts may be legally required in many jurisdictions, encouraged through vehicle onboard warning systems, and encouraged through promotional campaigns, and yet a substantial number of vehicle operators and other occupants still do not comply. Many operators ignore, disconnect, and/or dismiss these compliance mechanisms.

This background discussion is intended to provide information related to the present invention which is not necessarily prior art.

### SUMMARY

Embodiments of the present invention solve the above-described and other problems and limitations by providing a system and method for improving the usage of vehicle safety belts during operation of motor vehicles by preventing those vehicles from starting when the safety belts are not engaged, thereby giving owners of or others responsible for vehicles more control over the behavior of operators and other occupants of those vehicles.

In one embodiment of the present invention, a system is provided for controlling operation of a vehicle including an onboard computer, a safety belt monitoring system, a seat, and a safety belt associated with the seat. The system broadly comprises a connector and a hand-held unit. The connector is configured to allow for communication with the onboard computer. The hand-held unit is configured to allow for communicating with the onboard computer via the connector in order to program the onboard computer to require both entry of a code and engagement of the safety belt, as determined by the safety belt monitoring system, before allowing the vehicle to start.

In another embodiment, a method is provided for controlling operation of a vehicle including an onboard computer, a safety belt monitoring system, a seat, and a safety belt associated with the seat. The method broadly comprises the following steps. A connector is provided configured to allow for communication with the onboard computer. A hand-held unit is configured to communicate with the onboard computer via the connector. The hand-held unit is further configured to allow for programming the onboard computer to require both entry of a code and engagement of the safety belt, as determined by the safety belt monitoring system, before allowing the vehicle to start.

Various implementations of the foregoing embodiments may include any one or more of the following additional features. The hand-held unit may include a touchscreen configured to facilitate entry of the code. The hand-held unit may be a mobile communication device, such as a smart phone, configured to wirelessly communicate with the connector via a wireless communication network. The code may contain between two (2) and ten (10) characters.

The vehicle may include a plurality of seats and a plurality of safety belts, and the hand-held unit may be configured to program the onboard computer to require both entry of the code and engagement of the safety belt associated with each seat that is occupied by a person, as determined by the safety belt monitoring system, before allowing the vehicle to start. Further, one or more of the plurality of seats may be front seats, and one or more may be back seats, and the hand-held unit may be configured to program the onboard computer to require both entry of the code and engagement of the safety belt associated with each front seat that is occupied by a person, as determined by the safety belt monitoring system, before allowing the vehicle to start.

The connector and the hand-held unit may both be integrated into the vehicle. Alternatively, the connector may be integrated into the vehicle, and the hand-held unit may be a mobile communication device, such as a smart phone, configured to wirelessly communicate with the connector via a wireless communication network.

The hand-held unit may be configured to program the onboard computer to require that the code be entered again before allowing the vehicle to start again if the safety belt is disengaged during operation of the vehicle and a transmission of the vehicle is not in “park” or “neutral”.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is an exploded view of an exemplary vehicle and relevant components thereof;

FIG. 2 is a diagram of an embodiment of a system for controlling operation of the exemplary vehicle of FIG. 1 based on engagement of a safety belt component of the vehicle; and

FIG. 3 is a flowchart of steps involved in an embodiment of a method for controlling operation of the exemplary vehicle of FIG. 1 based on engagement of the safety belt component of the vehicle.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, embodiments of the present invention provide a system and method for improving the usage of vehicle safety belts during operation of motor vehicles by preventing those vehicles from starting when the safety belts are not engaged. More specifically, a vehicle onboard computer system may be used to determine whether the operator's and any passengers' safety belts are engaged, and to prevent the vehicle from starting until the safety belts are engaged. Thus, the present invention gives owners of or others responsible for vehicles more control over the behaviour of operators and other occupants of those vehicles. The present invention may be used by, for example, parents desiring to ensure that their children use safety belts when operating family vehicles, private and public entities desiring to ensure that operators of fleet vehicles use safety belts, and, more generally, any safety conscious vehicle owner. Further, use of the present invention may become encouraged or required by insurers of motor vehicles in order to reduce injury claims resulting from motor vehicle accidents.

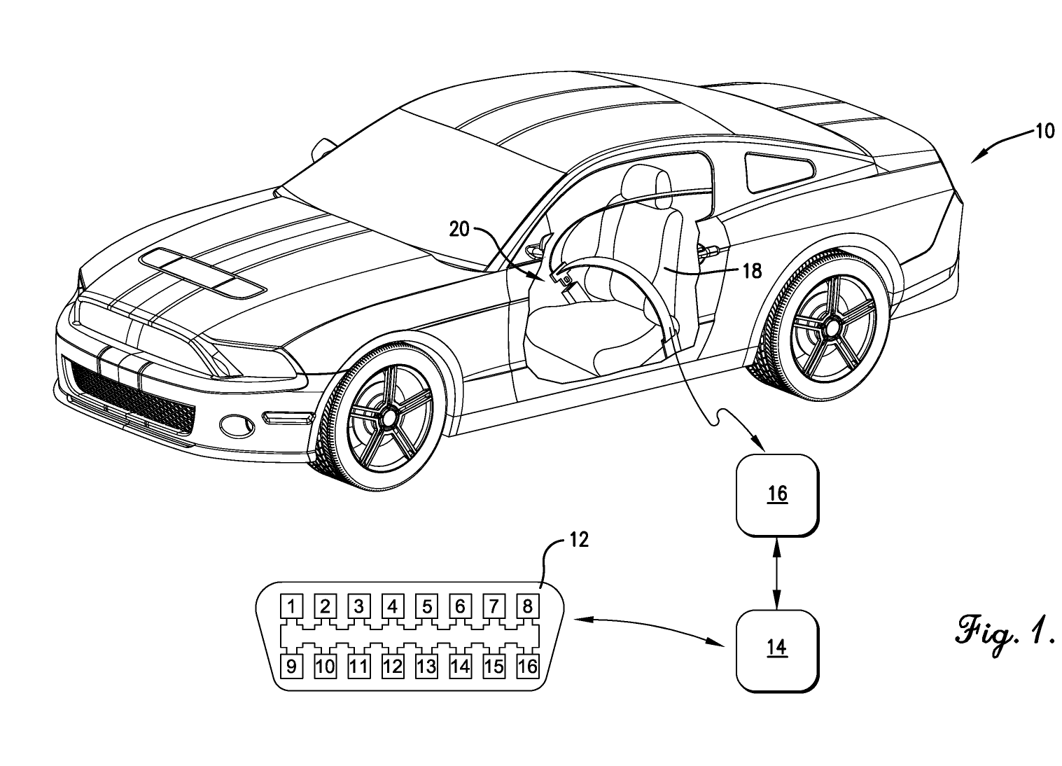

Referring to FIG. 1, an exemplary vehicle 10 may comprise a connection port 12, a vehicle onboard computer 14, a safety belt monitoring system 16, seats 18, and safety belts 20. The connection port 12 may be configured to facilitate accessing, directly or indirectly, the vehicle onboard computer 14. In various implementations, the connection port 12 may be part of a vehicle onboard diagnostic (OBD) system, a universal serial bus (USB) port, or substantially any other suitable port. The vehicle onboard computer 14 may be configured to control various vehicle functions, including starting of the vehicle 10. The safety belt monitoring system 16 may be configured to determine whether the seats 18 are occupied and whether the safety belts 20 associated with occupied seats 18 are engaged. The safety belts 20 may be configured to retain the occupants of the seats 18.

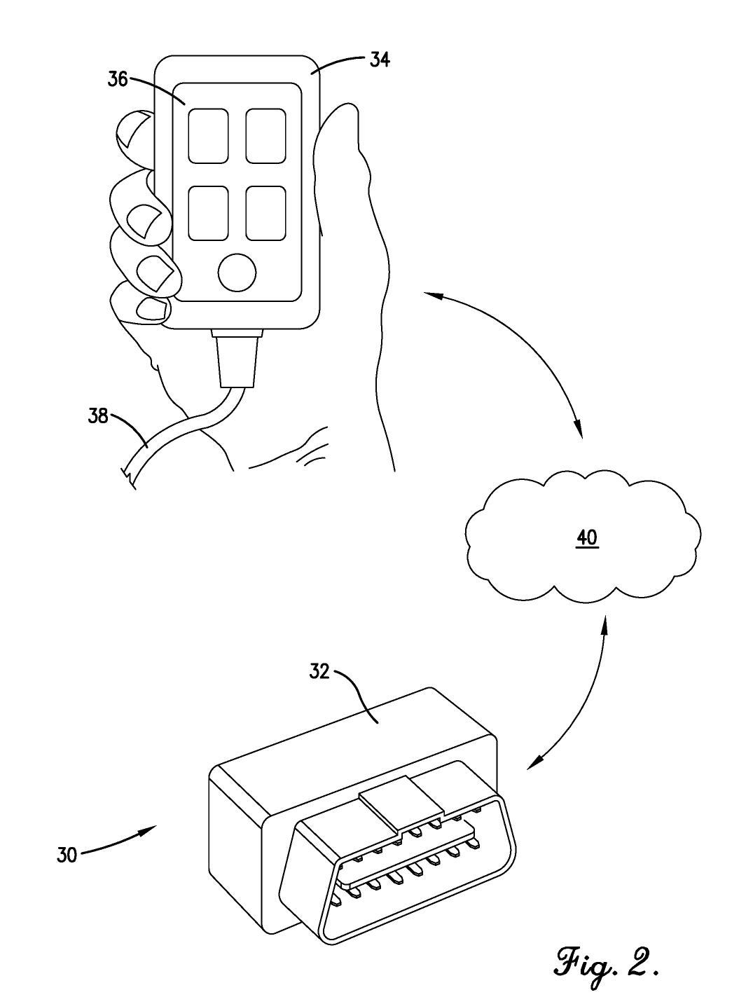

Referring also to FIG. 2, in an exemplary embodiment, the system 30 of the present invention may be configured for use with the exemplary vehicle 10, and may broadly comprise a connector 32 and a hand-held unit 34. The connector 32 may be configured to allow for wired or wireless communication with the onboard computer 14 via the connection port 12, possibly through the OBD system. In wireless form, the connector 32 may be a Bluetooth wireless connector. The connector 32 may be constructed of a high grade plastic or other similarly suitable material.

The handheld-held unit 34 may be configured to allow a user to program the vehicle onboard computer 14. More specifically, the hand-held unit 34 may contain hardware, software, firmware, or any combination thereof configured to allow the user to interface with the vehicle onboard computer 14 via the connector 32, and to allow the user to reprogram the vehicle start and run procedure to require entry of a password or other code and engagement of the vehicle safety belts 20, as determined by the vehicle safety belt monitoring system 16, before starting the vehicle 10. In various exemplary implementations, this control over the operation of the vehicle 10 may be achieved through hardware, software, or any combination thereof, such as, for example, through software configured to prevent an electronic start signal from reaching the vehicle onboard computer 14 until the start criteria are satisfied, or through software configured to cause the vehicle onboard computer 14 to refrain from acting on a received electronic start signal until the start criteria are satisfied (such as, for example, by not engaging a fuel system or starter). The hand-held unit 34 may include an interactive touch screen display 36 to facilitate entering the code and other interaction. In one implementation, the hand-held unit 34 may be wiredly connected to the connector 32 by a physical connection 38, while in another implementation, the hand-held unit 34 may be configured to allow for wireless communication with the connector 32 via a wireless communication network 40. Further, the hand-held device 34 may be a smart phone or similar mobile communication device configured to access the wireless communication network 40. Such configuration of the hand-held unit 34 in the form of a mobile communication device may be accomplished by providing a software application (or “app”) for electronic download to the mobile communication device via the wireless communication network 40. The hand-held unit 34 may be constructed of a high grade plastic or other similarly suitable material.

The code may be a multi-character (e.g., between two (2) and ten (10) characters, or between two (2) and six (6) characters, or four (4) characters) code which is input to the vehicle onboard computer 14 via the hand-held device 34 and the connector 32. The characters may be limited to letters or numbers, or may include a combination of letters, numbers, and/or symbols. In one implementation, entry of the code may only be necessary to initially configure the vehicle 10. Thereafter, re-entry of the code may only be required if one or more of the engaged safety belts 20 are disengaged during operation of the vehicle 10. More specifically, if a safety belt 20 associated with an occupied seat 18 is disengaged during operation and the vehicle transmission is not in “park” or (in the case of a manual transmission) “neutral”, the vehicle 10 may continue to operate normally until the vehicle engine has stopped, and then re-entry of the code may be required before the vehicle 10 can be re-started. Thus, in addition to ensuring that the safety belts 20 are initially engaged, the present invention can indicate whether the safety belts 20 were inappropriately dis-engaged while the vehicle 10 was in operation.

In various implementations, the system 30 may require only that the safety belts associated with occupied front seats be engaged, may require that the safety belts of occupied front and rear seats be engaged, or may allow the user to choose whether only the safety belts associated with occupied front seats must be engaged or whether the safety belts of occupied front and rear seats must be engaged.

It will be appreciated that the connector 32 and/or hand-held unit 34 may be integrated into the vehicle 10 by the vehicle manufacturer. For example, the connector 32 may be integrated into the vehicle 10 as, e.g., an integrated wireless receiver, without changing the basic concept and functionality of the present invention. For another example, the hand-held unit 34 may be integrated into the vehicle 10 so as to have direct access to the vehicle onboard computer 14, which may or may not eliminate the need for the connector 32, without changing the basic concept and functionality of the present invention.

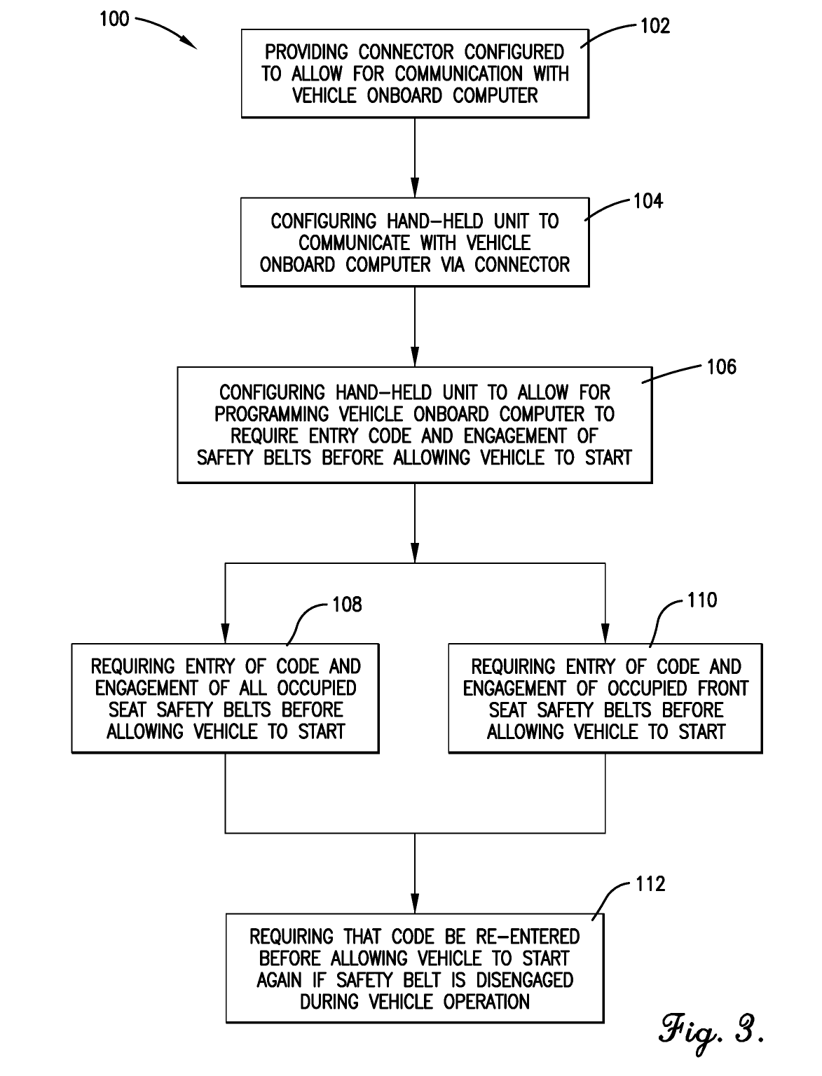

Referring to FIG. 3, in operation an exemplary embodiment of a method 100 of the present invention may proceed substantially as follows to reprogram the vehicle onboard computer 14 to prevent the vehicle 10 from starting until the code has been entered and the safety belt 20 is engaged. The connector 32 may be provided and configured to allow for communication with the onboard computer 14, as shown in 102. The hand-held unit 34 may be configured to allow for communication with the onboard computer 14 via the connector 32, as shown in 104. The hand-held unit 34 may be further configured to allow for programming the onboard computer 14 to require both entry of the code and engagement of the safety belt 20, as determined by the safety belt monitoring system 16, before allowing the vehicle 10 to start, as shown in 106.

In one implementation, the vehicle 10 may include a plurality of seats 18 and a plurality of safety belts 20, and the method 100 may include configuring the hand-held unit 34 to allow for programming the onboard computer 14 to require both entry of the code and engagement of the safety belt 18 associated with each occupied seat, as determined by the safety belt monitoring system 16, before allowing the vehicle 10 to start, as shown in 108. Alternatively, one or more of the plurality of seats 18 may be front seats, and one or more of the plurality of seats 18 may be back seats, and the method 100 may include configuring the hand-held unit 34 to allow for programming the onboard computer 14 to require both entry of the code and engagement of the safety belt 20 associated with each occupied front seat, as determined by the safety belt monitoring system 16, before allowing the vehicle 10 to start, as shown in 110.

In one implementation, the method 100 may include configuring the hand-held unit 34 to allow for programming the onboard computer 14 to require that the code be entered again before allowing the vehicle 10 to start again if the safety belt 20 of an occupied seat is disengaged during operation of the vehicle 10 and a transmission of the vehicle 10 is not in a “park” mode or a “neutral” mode, as shown in 112.

In exemplary operation, with the connector 32 connected to the connection port 12, the vehicle key switch may be moved to the “on” position, and the code may be input via the hand-held unit 34 to allow the vehicle 10 to start. Thereafter, the vehicle 10 will start if all monitored safety belts of some or all occupied seats 18 (i.e., only front seats or both front and back seats) are appropriately engaged. If a safety belt 20 associated with an occupied seat 18 is disengaged during operation and the vehicle transmission is not in “park” mode or “neutral” mode, the vehicle 10 may continue to operate normally until the vehicle engine has stopped, and then re-entry of the code may be required before the vehicle 10 can be re-started, thereby communicating to the owner of or other person responsible for the vehicle that the operator or other occupant of the vehicle 10 may have acted unsafely.

Thus, the present invention provides a system and method for advantageously improving the usage of vehicle safety belts during operation of motor vehicles by preventing those vehicles from starting when the safety belts are not engaged, thereby giving owners of or others responsible for vehicles more control over the behaviour of operators and other occupants of those vehicles.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for controlling operation of a vehicle, the vehicle including an onboard computer, a safety belt monitoring system, a seat, and a safety belt associated with the seat, the system comprising:
a connector configured to allow for communication with the onboard computer; and
a hand-held unit configured to allow for communicating with the onboard computer via the connector in order to program the onboard computer to require both entry of a code and engagement of the safety belt, as determined by the safety belt monitoring system, before allowing the vehicle to start.

2. The system as set forth in claim 1, wherein the hand-held unit includes a touchscreen configured to facilitate entry of the code.

3. The system as set forth in claim 1, wherein the hand-held unit is a mobile communication device configured to wirelessly communicate with the connector via a wireless communication network.

4. The system as set forth in claim 1, wherein the code contains between two and ten characters.

5. The system as set forth in claim 1, wherein the vehicle includes a plurality of seats and a plurality of safety belts, and the hand-held unit is configured to program the onboard computer to require both entry of the code and engagement of the safety belt associated with each seat that is occupied by a person, as determined by the safety belt monitoring system, before allowing the vehicle to start.

6. The system as set forth in claim 1, wherein the vehicle includes one or more front seats associated with safety belts, and one or more back seats associated with safety belts, and the hand-held unit is configured to program the onboard computer to require both entry of the code and engagement of the safety belt associated with each front seat that is occupied by a person, as determined by the safety belt monitoring system, before allowing the vehicle to start.

7. The system as set forth in claim 1, wherein the connector and the hand-held unit are both integrated into the vehicle.

8. The system as set forth in claim 1, wherein the connector is integrated into the vehicle, and the hand-held unit is a mobile communication device configured to wirelessly communicate with the connector via a wireless communication network.

9. The system as set forth in claim 1, wherein the hand-held unit is configured to program the onboard computer to require that the code be entered again before allowing the vehicle to start again if the safety belt is disengaged during operation of the vehicle and a transmission of the vehicle is not in a park mode or a neutral mode.

10. A system for controlling operation of a vehicle, the vehicle including a connection port, an onboard computer, a safety belt monitoring system, a seat, and a safety belt associated with the seat, the system comprising:
a connector configured to allow for communication with the onboard computer via the connection port; and
a hand-held unit in the form of a mobile communication device configured to allow for wirelessly communicating with the onboard computer via the connector using a wireless communication network in order to program the onboard computer to require both entry of a code and engagement of the safety belt, as determined by the safety belt monitoring system, before allowing the vehicle to start, wherein the hand-held unit, and the hand-held unit includes a touchscreen configured to facilitate entry of the code.

11. The system as set forth in claim 10, wherein the connection port is part of an onboard diagnostic system of the vehicle.

12. The system as set forth in claim 10, wherein the connection port is a universal serial bus port of the vehicle.

13. The system as set forth in claim 10, wherein the code contains between two and ten characters.

14. The system as set forth in claim 10, wherein the vehicle includes a plurality of seats and a plurality of safety belts, and the hand-held unit is configured to program the onboard computer to require both entry of the code and engagement of the safety belt associated with each seat that is occupied by a person, as determined by the safety belt monitoring system, before allowing the vehicle to start.

15. The system as set forth in claim 10, wherein the vehicle includes one or more front seats associated with safety belts, and one or more back seats associated with safety belts, and the hand-held unit is configured to program the onboard computer to require both entry of the code and engagement of the safety belt associated with each front seat that is occupied by a person, as determined by the safety belt monitoring system, before allowing the vehicle to start.

16. The system as set forth in claim 10, wherein the hand-held unit is configured to program the onboard computer to require that the code be entered again before allowing the vehicle to start again if the safety belt is disengaged during operation of the vehicle and a transmission of the vehicle is not in a park mode or a neutral mode.

17. A method for controlling operation of a vehicle, the vehicle including an onboard computer, a safety belt monitoring system, a seat, and a safety belt associated with the seat, the method comprising:
providing a connector configured to allow for communication with the onboard computer;
configuring a hand-held unit to communicate with the onboard computer via the connector; and
configuring the hand-held unit to program the onboard computer to require both entry of a code and engagement of the safety belt, as determined by the safety belt monitoring system, before allowing the vehicle to start.

18. The method as set forth in claim 17, wherein the vehicle includes a plurality of seats and a plurality of safety belts, and the method includes configuring the hand-held unit to program the onboard computer to require both entry of the code and engagement of the safety belt associated with each seat that is occupied by a person, as determined by the safety belt monitoring system, before allowing the vehicle to start.

19. The method as set forth in claim 17, wherein the vehicle includes one or more front seats associated with safety belts, and one or more back seats associated with safety belts, and the method includes configuring the hand-held unit to program the onboard computer to require both entry of the code and engagement of the safety belt associated with each front seat that is occupied by a person, as determined by the safety belt monitoring system, before allowing the vehicle to start.

20. The method as set forth in claim 17, wherein the method includes configuring the hand-held unit to program the onboard computer to require that the code be entered again before allowing the vehicle to start again if the safety belt is disengaged during operation of the vehicle and a transmission of the vehicle is not in a park mode or a neutral mode.
